(19) United States
(12) Patent Application Publication
(10) Pub. No.: US 2019/0087824 A1
(43) Pub. Date: Mar. 21, 2019

(54) SYSTEM AND METHOD FOR MITIGATING EFFECTS OF IDENTITY THEFT

(71) Applicant: Vernon Glass, Jr., Romulus, MI (US)

(72) Inventor: Vernon Glass, Jr., Romulus, MI (US)

(21) Appl. No.: 16/126,446

(22) Filed: Sep. 10, 2018

Related U.S. Application Data
(60) Provisional application No. 62/540,928, filed on Aug. 3, 2017.

(51) Int. Cl. G06Q 20/40; G06K 9/00

(52) U.S. Cl. CPC G06Q 20/40145; G06K 9/00255; G06Q 20/4016

(57) ABSTRACT

A system and method for mitigating effects of identity theft in transactions that works in real time to identify instances of identity theft. The system may include an authentication module that processes one or more authentication data elements tendered in connection with a transaction request. A confidence module determines a confidence level for the requested transaction based on the available authentication data. At least a portion of the transaction is processed based on the confidence level assigned to the transaction.

### CROSS-REFERENCE TO RELATED APPLICATION

This application claims the benefit of priority of U.S. provisional application No. 62/540,928, filed Aug. 3, 2017, the contents of which are herein incorporated by reference.

### FIELD OF THE INVENTION

The present disclosure generally relates to performing secure transactions. Specifically, the disclosure relates to methods and systems for mitigating effects of identity theft for performing secure transactions.

### BACKGROUND OF THE INVENTION

Identity theft remains alarmingly high in credit card and check processing, given the fact that there seems to be minimal barriers for identification in these two mediums. While mobile technology has made its way into banking and finance, identity theft is still a prevalent issue with little developments in tackling it. According to some estimates, an estimated 15.4 million consumers in the US were hit with some kind of ID theft in 2016.

Accordingly, there is a need for a more effective system and method for mitigate effects of identity theft and perform secure transactions.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

According to some aspects, the present disclosure provides an identity theft mitigation system for mitigating effects of identity theft. The identity theft mitigation system may include an authentication module to receive authentication data. Further, the identity theft mitigation system may include a confidence determination module to determine a confidence level for a particular transaction. Yet further, the identity theft mitigation system may include an authorization module to authorize an amount based on the confidence level of the particular transaction.

According to some aspects, the present disclosure provides a method for mitigating effects of identity theft. In case of identity theft, the method restricts the amount withdrawn by the unauthorized user to a minimum amount (such as $50). The minimum amount may equal the amount insured by a service provider (such as Fraudscan).

According to some aspects, the present disclosure provides a mobile application named “Identity Processing Data”, (IPD). The IPD application is a credit card and check cashing processing database application that may be designed to protect users from identity theft. The IPD application may allow users to keep track of their credit card and check transactions by initially using their fingerprints. For disabled individuals who cannot provide their fingerprints, they can have an authorized account user registered of the credit card or with the financial institution where a person maintains an account for processing. Further, the IPD application may use facial recognition by gaining access to the camera of the respective device and a personalized security code to update records. The IPD application may also be used to place orders and process checks of money orders, bank checks, government checks and payroll checks.

According to further aspects, the IPD database application may work in conjunction with a credit processing machine (Fraudscan) that collects the user identity using the same standard as law enforcement agencies.

Further, the IPD application may be available on both iOS and Android platforms. The IPD application may be essential for the everyday consumer and may be readily available at online application stores.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

These and other features, aspects and advantages of the present invention will become better understood with reference to the following drawings, description and claims.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose. Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure;

FIG. 2 is a flowchart of a method for mitigating effects of identity theft, in accordance with an exemplary embodiment;

FIG. 3 is a block diagram of an identity theft mitigation system for mitigating effects of identity theft, in accordance with an exemplary embodiment;

FIG. 4 illustrates various applications of a disclosed mobile application, in accordance with an exemplary embodiment; and

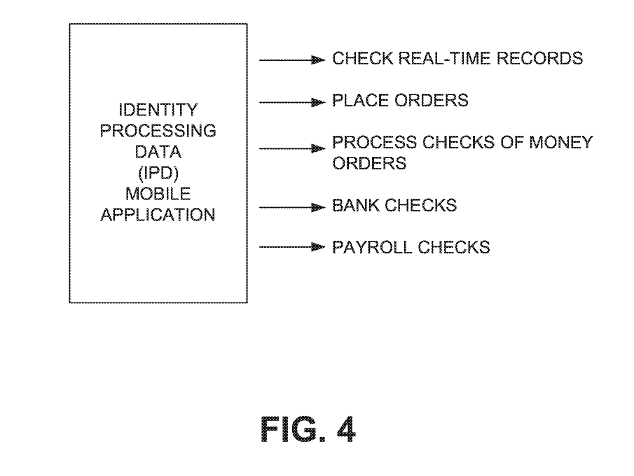

FIG. 5 is a block diagram of a computing device for implementing the methods disclosed herein, in accordance with some embodiments.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

As a preliminary matter, it will readily be understood by one having ordinary skill in the relevant art that the present disclosure has broad utility and application. As should be understood, any embodiment may incorporate only one or a plurality of the above disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of mitigating effects of identity theft, embodiments of the present disclosure are not limited to use only in this context.

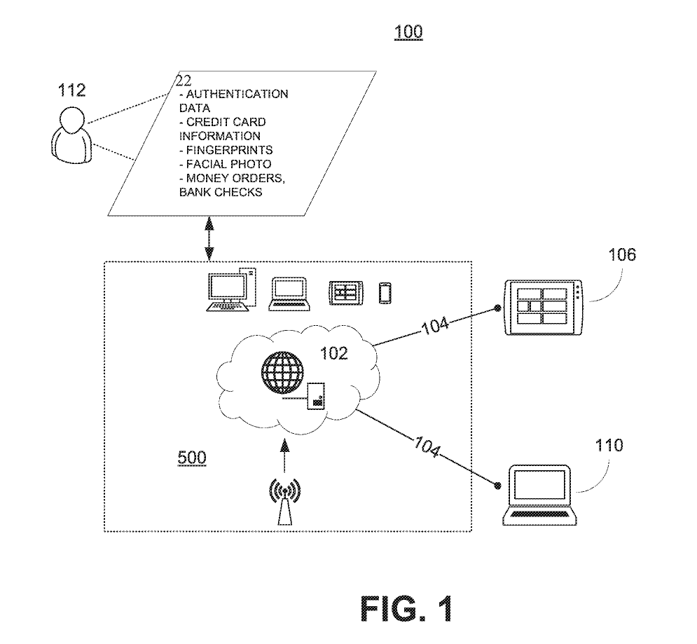

FIG. 1 is an illustration of an online platform 100 consistent with various embodiments of the present disclosure. By way of non-limiting example, the online platform 100 for mitigating effects of identity theft may be hosted on a centralized server 102, such as, for example, a cloud computing service. The centralized server 102 may communicate with other network entities, such as, for example, a mobile device 106 (such as a smartphone, a laptop, a tablet computer etc.) and a credit processing machine 110 over a communication network 104, such as, but not limited to, the Internet. Further, users of the platform may include relevant parties such as one or more of individuals, business owner, financial institutions, administrators and so on. Accordingly, electronic devices 106, 110 operated by the one or more relevant parties may be in communication with the platform. For example, the mobile device 106 may be operated by a business owner to keep track of their credit card and check transactions.

A user 112, such as the one or more relevant parties, may access platform 100 through a software application. The software application 10 may be embodied as, for example, but not be limited to, a website, a web application, a desktop application, and a mobile application compatible with a computing device 500.

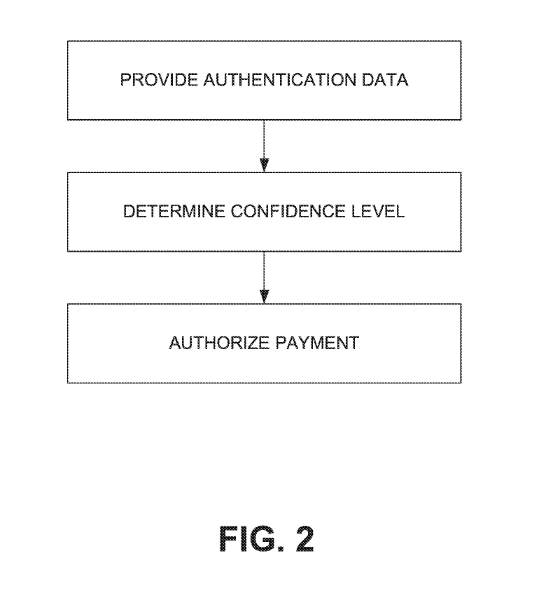

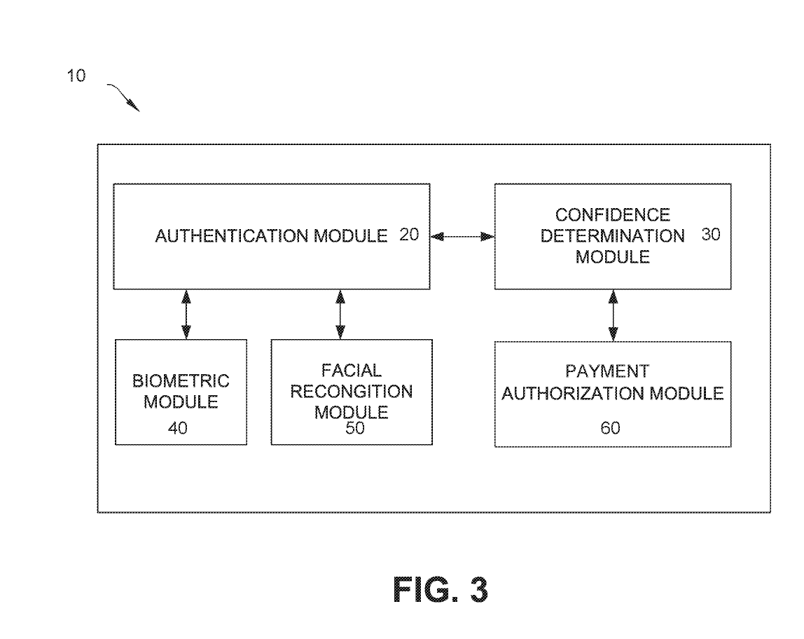

FIG. 2 is a flowchart of a method for mitigating effects of identity theft, in accordance with an exemplary embodiment. FIG. 3 is a block diagram of an identity theft mitigation system for mitigating effects of identity theft 10, in accordance with an exemplary embodiment.

First, a user may provide authentication data to an authentication module 20. For example, the user 112 may provide authentication data at one of a POS terminal and an online store. The authentication data 22 may include one or more of credit card information (obtained via a credit card swipe), credit card number (along with date of expiry), a pin number, a one-time password (OTP), a fingerprint and other biometric data (such as Iris scan, facial characteristics).

In some embodiments, the authentication data 22 may include multiple data elements such as, credit card information (obtained via a credit card swipe), credit card number (along with date of expiry), a pin number, a one-time password (OTP), fingerprints and other biometric data (such as Iris scan, facial characteristics).

The authentication module 20 may receive biometric information from a biometric module 40. The authentication module 20 may also receive facial information from a facial recognition module 50. The received biometric and facial recognition information may be compared to a record biometric and facial image data of the authorized user use by the authentication module 20.

In some embodiments, the authentication data 22 may also include user data received from public databases such as, but not limited to, telephone directories, social media accounts, and electoral roll. The social media accounts may provide user data such as user's location, and user's employment record.

Thereafter, a confidence determination module 30 may determine a confidence level based on the authentication data 22 received by the authentication module 20. For example, if the authentication module 20 only receives a credit card information obtained via a credit card swipe, then the confidence level may determined be low. However, if the authentication module 20 receives an OTP along with the credit card information, then the confidence level may be returned higher.

Further, the confidence determination module 30 may obtain the authentication data 22 from public databases. Therefore, if a telephone number of a user 112 is verified, then again the confidence level may be higher. Likewise, if the authentication data 22 includes one or more of a biometric identification from the biometric module 40 or a facial recognition authentication from the facial recognition module 50, the confidence determination module 30 may accordingly assign a high confidence level for the requested transaction.

Thereafter, a payment authorization module 60 may authorize payment of an amount based on the confidence level determined by the confidence determination module 30. If the confidence level is high, indicating a high likelihood that the transaction initiator is an authorized user, then a full payment is authorized by the payment authorization module 60. However, if the confidence level is determined to be below a specified threshold, indicating a high likelihood that the requested transaction may an instance of identity theft, the payment authorization module 60 may authorize only a minimum amount for the transaction.

For example, the minimum amount may be $50. Authorizing a minimum amount ensures a stronger legal case, in case an identity theft event is shown later on, in that a theft has actually occurred. The case may be assisted, using, in part the identity data collected from the perpetrator by the authentication module 20.

Further, the transaction approval amount may vary based on settings of one or more confidence levels. For example, a family member may use a credit card, wherein the family member is not able to provide all the authentication data 22 required to process a particular transaction, they may still be able to execute a partial transaction. Accordingly, the confidence determination module 30 may determine an intermediate value of confidence level for the transaction; therefore, an intermediate payment level may be specified. For example, the intermediate payment level may be set at a higher threshold limit than the minimum specified for that of the low confidence instance. The payment authorization module 60 may then process payments below the specified intermediate threshold.

Further, the IPD application allows users to keep track of their credit card or checking account transactions by initially using a biometric measurement, such as their fingerprint, which is read by a finger print reader operatively connected to the computing device, such as POS counter.

Alternatively, or in addition to biometric scan, the IPD application may use facial recognition by providing access to the camera of the device and a personalized security code to update and validate records. The IPD application may also be used for multiple transaction applications including, but not limited to, placing orders and processing checks of money orders, bank checks, government checks and payroll checks.

The IPD may include an application for a credit processing machine (Fraudscan) that collects the user identity data, including one or more of a biometric data element and a facial image capture, of the individual during a transaction request. If the system detects a miscompare event between the tendered credit card and the authorized user, the system will send an alert to the authorized user notifying them of the miscompare event. The alert may include the facial image of the person attempting the transaction.

If the authorized user approves the card user within a specified temporal time period, such as two to three minutes for a POS checkout line or a longer duration in situations where the transaction may not be dependent on a desirable customer flow, the transaction is approved. By way of example, this may be useful in the case of a family member, or office worker who has been tasked to go to a store of food vendor at the direction of the authorized user. If the authorized user does not approve the transaction within the specified temporal time period, the transaction is immediately declined, and the image or biometric data elements tagged as a possible identity theft perpetrator. If the authorized user approves the transaction after the specified temporal time period, the image or biometric data elements may be untagged as a possible identity theft perpetrator.

If the authorized user declines the request in the alert, the user identity data may be stored using the same standards as law enforcement agencies for evidentiary purposes. In the case of an identity theft event, the unauthorized user may not be able to withdraw more than a predetermined security limit. By way of non-limiting example, the security limit may be $50, which is a limit that is insured by the service provider (Fraudscan). The system may then to alert other participants in the network that the identity of the individual may be tied to identity theft activities. The system may then be used to alert law enforcement personnel upon a subsequent event by the identified user.

In certain preferred embodiments, the user's biometric and facial recognition identification data may be used in lieu of a credit card to or other form of card-based identification to initiate a transaction. By way of non-limiting example, a business or other service provider affiliated with the system may initiate a transaction by receiving one or more of a biometric or facial image of the customer at a POS counter.

If the customer has registered with the system, which may include a linking of one or more financial or other accounts for tendering a payment species, and providing one or more of a record biometric identification or a record facial recognition identification, the system will provide a confirmed identification of the customer to the vendor. If a payment species is required, such as for a purchase, the customer may then select from the one or more linked accounts to tender an acceptable payment species to the vendor, and the transaction may be completed. If a payment species is not required, such as a record retrieval transaction, the transaction may be completed based on the confirmed identity of the recipient of the records.

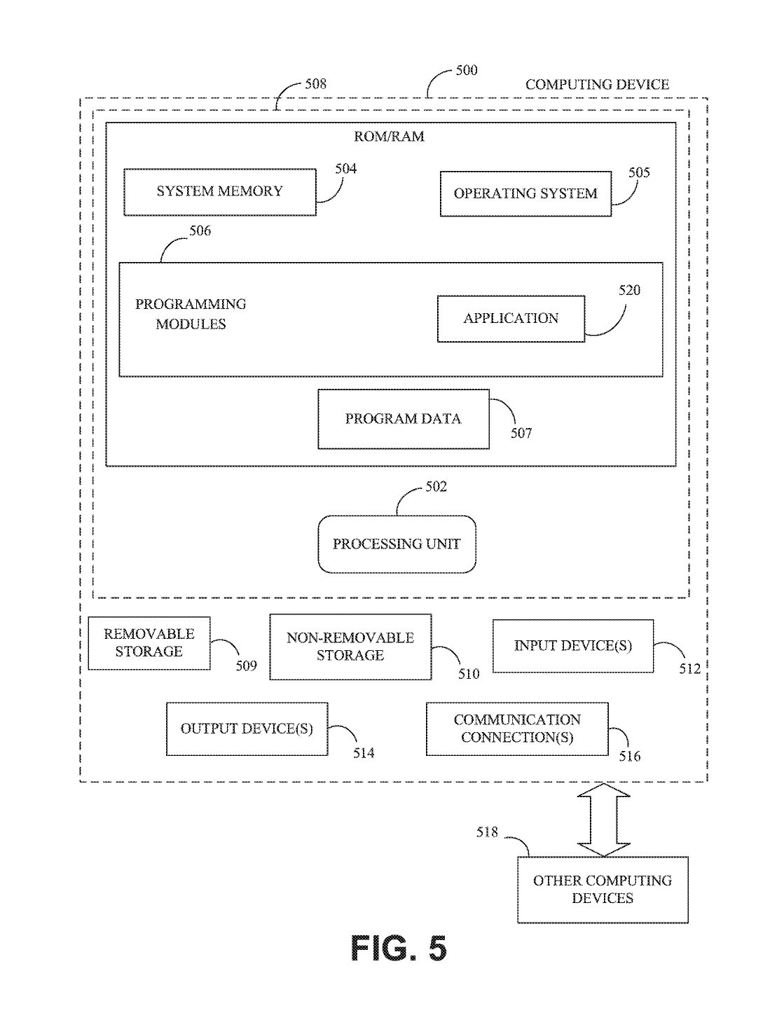

FIG. 5 is a block diagram of a system including computing device 500. Consistent with an embodiment of the disclosure, the aforementioned storage device and processing device may be implemented in a computing device, such as computing device 500 of FIG. 5. Any suitable combination of hardware, software, or firmware may be used to implement the memory storage and processing unit. For example, the storage device and the processing device may be implemented with computing device 500 or any of other computing devices 518, in combination with computing device 500. The aforementioned system, device, and processors are examples and other systems, devices, and processors may comprise the aforementioned storage device and processing device, consistent with embodiments of the disclosure.

With reference to FIG. 5, a system consistent with an embodiment of the disclosure may include a computing device or cloud service, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash 30 memory, or any combination. System memory 504 may include operating system 505, one or more programming modules 506, and may include a program data 507. Operating system 505, for example, may be suitable for controlling computing device 500's operation. In one embodiment, programming modules 506 may include image encoding module, machine learning module and image classifying module. Furthermore, embodiments of the disclosure may be practiced in conjunction with a graphics library, other operating systems, or any other application program and is 5 not limited to any particular application or system. This basic configuration is illustrated in FIG. 5 by those components within a dashed line 508.

Computing device 500 may have additional features or functionality. For example, computing device 500 may also include additional data storage devices 10 (removable and/or non-removable) such as, for example, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer-readable instructions, data 15 structures, program modules, or other data. System memory 504, removable storage 509, and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic 20 cassettes, magnetic tape, magnetic disk storage or other magnetic storage devices, or any other medium which can be used to store information and which can be accessed by computing device 500. Any such computer storage media may be part of device 500.

Computing device 500 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

Computing device 500 may also contain a communication connection 516 that may allow device 500 to communicate with other computing devices 518, such as over a network in a distributed computing environment, for example, an intranet or the Internet. Communication connection 516 is one example of communication media. Communication media may typically be embodied by computer readable instructions, data structures, program modules, or other data in a modulated data signal, such as a carrier wave or other transport mechanism, and includes any information delivery media.

The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 504, including operating system 505. While executing on processing unit 502, programming modules 506 (e.g., application 520 such as a media player) may perform processes including, for example, one or more stages of methods, algorithms, systems, applications, servers, databases as described above. The aforementioned process is an example, and processing unit 502 may perform other processes. Other programming modules that may be used in accordance with embodiments of the present disclosure may include sound encoding/decoding applications, machine learning application, acoustic classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any non-transitory storage medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

It should be understood, of course, that the foregoing relates to exemplary embodiments of the invention and that modifications may be made without departing from the spirit and scope of the invention as set forth in the following claims.

What is claimed is:

1. A computerized identity theft mitigation system, for use by a user of a transaction execution system to initiate a transaction over a network platform, the system comprising:
a computer having a user interface; and
a program product comprising machine-readable program code for causing, when executed, the computer to perform the following process steps: comprising:
receiving one or more user authentication data elements from the user initiating a transaction request via an authentication module;
determining a confidence level for the transaction request based on the one or more user authentication data elements;
authorizing at least a portion of the requested transaction based on the confidence level of the transaction.

2. The identity theft mitigation system of claim 1, wherein the step of receiving one or more user authentication data elements further comprises one or more of:
biometric data of the user received by a biometric scanner in communication with the authentication module; and
facial recognition data of the user captured by a camera in communication with the authentication module.

3. The identity theft mitigation system of claim 2, further comprising:
setting a high confidence level when one of the biometric data or the facial recognition data matches a record data set of the user.

4. The identity theft mitigation system of claim 1, further comprising:
authorizing the transaction request in full when the confidence level is at least a specified high confidence level;
authorizing an intermediate portion of the transaction request when the confidence is at least a specified intermediate confidence level; and
authorizing a minimum portion of the transaction request when the confidence level is below a specified minimum confidence level.

5. The identity theft mitigation system of claim 4, further comprising:
storing the one or more user authentication data elements when the confidence level is below the specified high confidence level.

6. A non-transitory computer-readable memory adapted for use by a user of a identity theft mitigation client application to initiate a transaction over a network, the computer-readable memory used to direct a computer on the network to perform the steps of:
receiving one or more user authentication data elements from the user initiating a transaction request via an authentication module;
determining a confidence level for the transaction request based on the one or more user authentication data elements;
authorizing the requested transaction based on the confidence level of the transaction.

7. The non-transitory computer-readable memory of claim 6, wherein the step of receiving one or more user authentication data elements further comprises one or more of:
biometric data of the user received by a biometric scanner in communication with the authentication module; and
facial recognition data of the user captured by a camera in communication with the authentication module.

8. The non-transitory computer-readable memory of claim 6, further comprising:
setting a high confidence level when one of the biometric data or the facial recognition data matches a record data set of the user.

9. The non-transitory computer-readable memory of claim 6, further comprising:
authorizing the transaction request in full when the confidence level is at least a specified high confidence level;
authorizing an intermediate portion of the transaction request when the confidence is at least a specified intermediate confidence level; and
authorizing a minimum portion of the transaction request when the confidence level is below a specified minimum confidence level.

10. The identity theft mitigation system of claim 9, further comprising:
storing the one or more user authentication data elements when the confidence level is below the specified high confidence level.
